(19) United States
(12) Patent Application Publication
(10) Pub. No.: US 2018/0251387 A1
(43) Pub. Date: Sep. 6, 2018

(54) Electrolytic water production device and management system therefor

(71) Applicant: NIHON TRIM CO., LTD., Osaka-shi, Osaka (JP)

(72) Inventor: Yuji CHIYA, Nankoku-shi, Kochi (JP)

(21) Appl. No.: 15/753,133

(22) PCT Filed: Sep. 1, 2016
(86) PCT No.: PCT/JP2016/075628

§ 371 Date: Feb. 15, 2018

(30) Foreign Application Priority Data
Sep. 8, 2015 (JP) 2015-176234

(51) Int. Cl. C02F 1/461; C02F 1/00

(52) U.S. Cl. CPC C02F 1/46104; C02F 2209/008; C02F 1/001

(57) ABSTRACT

An electrolytic water production device 1 comprises a device main body 2 having an electrolytic cell 4, and a water purification cartridge 5. The device main body 2 is provided with a communicator 7 and a controller 8 having a memory portion 14 for storing internal data (B) of the device main body 2. when the communicator 7 is wirelessly connected with an external data medium 25, the controller 8 reads data from the external data medium 25 and updates the internal data (B) based on the data read from the external data medium 25.

### TECHNICAL FIELD

The present invention relates to an electrolytic water production device and that electrolyzes water to produce electrolytic hydrogen water.

### BACKGROUND ART

Generally, an electrolytic water production device comprises a removable water purification cartridge. The water purification cartridge needs to be replaced at regular intervals in accordance with a total water amount purified, an accumulated time of use, and the like. However, when a water purification cartridge (hereinafter may be referred to as a non-genuine cartridge) other than a dedicated water purification cartridge (hereinafter may be referred to as a genuine cartridge) designated by a manufacturer of the electrolytic water production device is used, it is possible that an accurate function of the electrolytic water production device is impaired or safety thereof cannot be ensured.

In view of the above, Patent Literature 1 (Japanese Unexamined Patent Application Publication No. 2012-016643) has proposed an electrolytic water production device in which an IC tag (wireless tag) is attached to a water purification cartridge, and a reader/writer device for reading data from the IC tag is attached to a main body of the device. By checking the data read from the IC tag with data of a list of usable water purification cartridges stored in advance in the main body of the device, it is possible to identify whether the water purification cartridge is genuine or not, therefore, it is possible to prevent a non-genuine cartridge from being used.

### CITATION LIST

### Patent Literature

Patent Literature 1: Japanese unexamined Patent Application Publication No. 2012-016643.

### SUMMARY OF THE INVENTION

### Problems to be Solved by the Invention

on the other hand, high-performance water purification cartridges are sometimes released as water purification function is improved by research and development and the like. In this case, it is necessary to update the data stored in the electrolytic water production devices released before the release of the above new water purification cartridge to add data of the new water purification cartridge. Besides this, internal data including a program may need to be updated depending on the function of the device and the preference of the user.

However, conventionally, it was difficult to update the internal data at a location where the device is installed and tubes are connected thereto. Therefore, the electrolytic water production device is brought back to the factory etc. disassembled, and then the internal data is updated by replacing the substrate. Therefore, it is possible that the maintenance work time and the work cost are increased.

An object of the present invention is to provide an electrolytic water production device and a management system therefor which can easily update internal data at the location where the device is installed and greatly contribute to reduction of maintenance work time and operation cost.

### Means for Solving the Problem

In a first aspect of the present invention, an electrolytic water production device comprises a device main body having an electrolytic cell for electrolyzing water, and a water purification cartridge exchangeably mounted on a mounting portion of the device main body and for purifying water before or after electrolysis, wherein the device main body is provided with a communicator and a controller having a memory portion for storing internal data of the device main body, and when the communicator is wirelessly connected with an external data medium, the controller reads data from the external data medium and updates the internal data based on the data read from the external data medium.

In the first aspect of the invention, it is preferred that the water purification cartridge is provided with a wireless tag, the communicator is capable of wirelessly connecting with the wireless tag of the water purification cartridge mounted on the mounting portion, and when the communicator is wirelessly connected with the wireless tag, the controller reads data from the wireless tag.

In the first aspect of the invention, it is preferred that the controller updates the internal data based on the data read from the wireless tag.

In the first aspect of the invention, it is preferred that when the external data medium comes close to the mounting portion without the water purification cartridge mounted thereon, the communicator is capable of wirelessly connecting with the external data medium, and when the communicator is wirelessly connected with the external data medium, the controller reads data from the external data medium, and updates the internal data based on the data read from the external data medium.

In the first aspect of the invention, it is preferred that the data to be updated based on the data read from the external data medium includes at least one of data of types of the water purification cartridge usable for the electrolytic water production device, data of melody played during electrolysis of water, data of LED lighting patterns, data of voice or buzzer sound played at the time of caution or warning, and a controlling program for controlling operation of the device main body.

In the first aspect of the invention, it is preferred that the external data medium is a mobile communication terminal or a tablet PC.

In a second aspect of the invention, a management system for an electrolytic water production device comprises the electrolytic water production device and the external data medium according to any one of the above.

### Advantageous Effects of the Invention

The device main body of the electrolytic water production device according to the first aspect of the present invention is provided with the communicator and the controller having the memory portion for storing the internal data of the device main body.

The controller has functions of reading the data for update from the external data medium and updating the internal data based on the read data for update when the communicator is wirelessly connected with the external data medium.

That is, it is possible to easily update the internal data at a location where the device is installed without disassembling the device main body and replacing the circuit board.
Thereby, the maintenance work time and the work cost can be reduced.

### BRIEF DESCRIPTION OF THE DRAWINGS

FIG. 1 is a perspective view schematically showing internal configuration of an electrolytic water production device according to an embodiment of the present invention.

FIG. 2 is a plan sectional view schematically showing the internal configuration of the electrolytic water production device of FIG. 1.

FIG. 3 is a conceptual diagram showing a configuration of the electrolytic water production device of FIG. 1.

FIG. 4 is a perspective view showing a state in which a device main body and an external data medium are wirelessly connected.

FIG. 5 is a conceptual diagram showing a state of the wireless connection in FIG. 4.

### DESCRIPTION OF THE PREFERRED EMBODIMENT

An embodiment of the present invention will now be described in detail below.

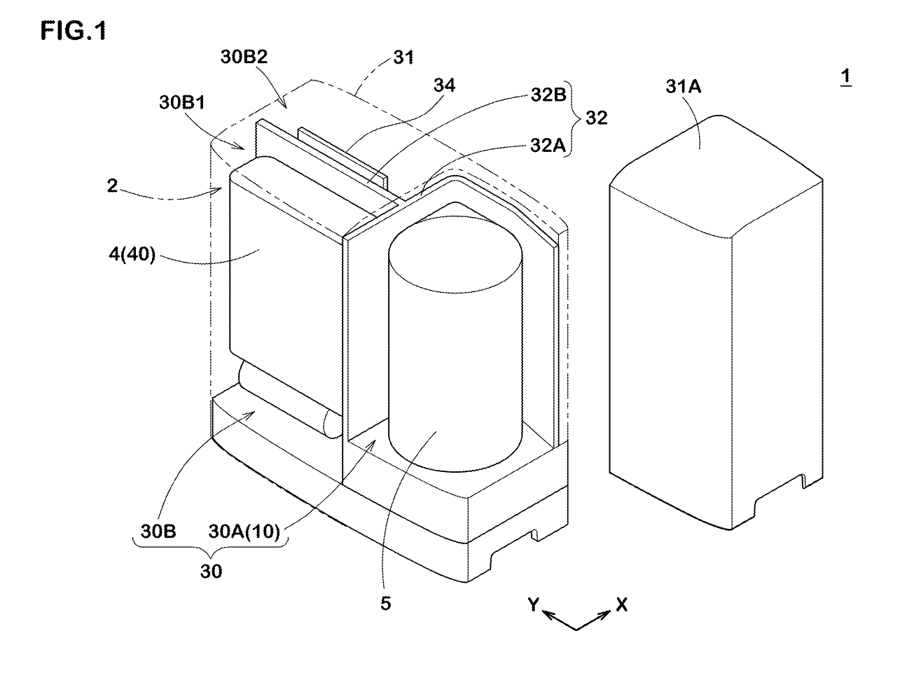

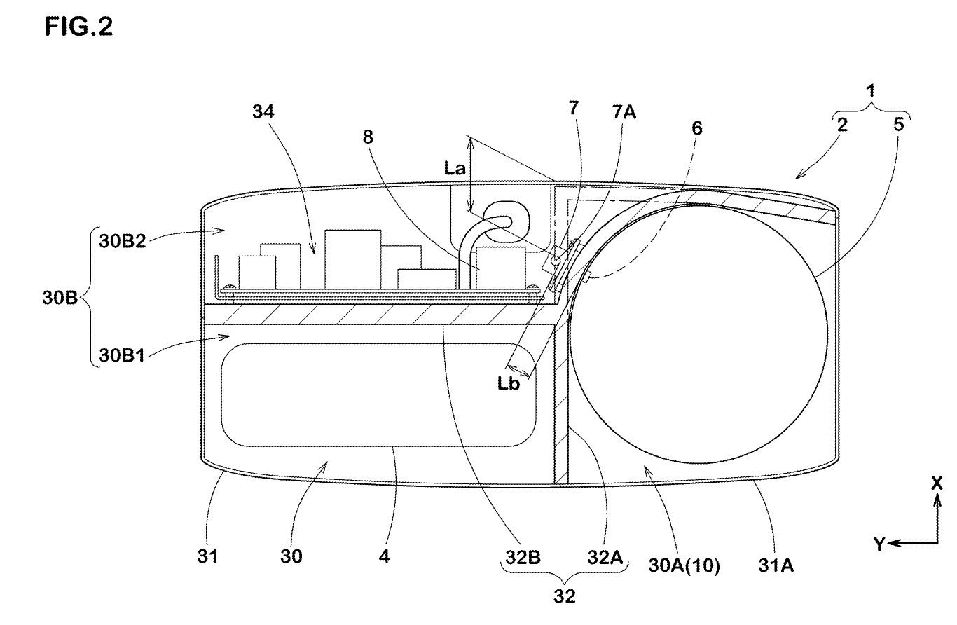

As shown in FIGS. 1 and 2, an electrolytic water production device 1 in this embodiment includes a device main body 2 having an electrolytic cell 4 for electrolyzing water, and a water purification cartridge 5 for purifying water before or after electrolysis.

The device main body 2 in this embodiment includes a case 31 surrounding the device main body 2 so as to define an accommodation space 30 therein, and a frame 32 dividing the accommodation space 30 into a plurality of spaces.

The frame 32 includes a first partition wall 32A extending in a device thickness direction (x) and a second partition wall 326 extending in a device width direction (Y) so as to intersect with the first partition wall 32A in a T-shape, for example. The first partition wall 32A divides the accommodation space 30 into a first space 30A arranged on one side in the device width direction (Y) and a second space 306 arranged on the other side in the device width direction (Y). Further, the second partition wall 326 divides the second space 306 into a third space 3061 arranged on one side (front side in this embodiment) in the device thickness direction (x) and a fourth space 3062 arranged on the other side (back side in this embodiment) in the device thickness direction (x).

In the first space 30A, the water purification cartridge 5 is accommodated. In the third space 3061, the electrolytic cell 4 is accommodated. Further, in the fourth space 3062, an electric member including a circuit board 34 for electrically controlling the electrolytic cell 4 is accommodated. The fourth space 3062 is separated from the first space 30A and the third space 3061 in a waterproof manner by the first partition wall 32A and the second partition wall 326. Thereby, even when water leakage occurs from the water purification cartridge 5 or the electrolytic cell 4, the electric member including the circuit board 34 can be protected from the leaked water.

The water purification cartridge 5 is exchangeably mounted on a mounting portion 10 which is the first space 30A. when it is time to replace the water purification cartridge 5, a user can open a lid portion 31A of the case 31 to expose the mounting portion 10 and replace the old water purification cartridge 5 with a new one, for example.

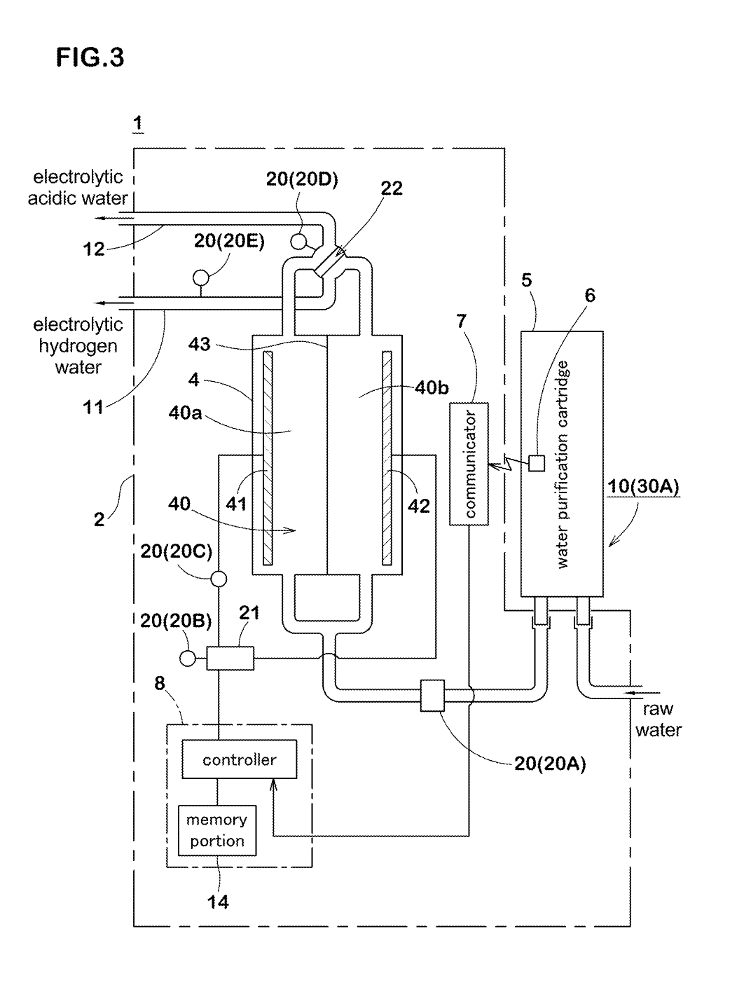

As conceptually shown in FIG. 3, in this embodiment, a preferred case is shown in which the water purification cartridge 5 is provided on an upstream side of the electrolytic cell 4 to purify water before electrolysis. The water purification cartridge 5 is supplied with raw water. Generally, tap water is used as the raw water, but in addition, well water, groundwater, etc. can be used, for example. The water purification cartridge 5 purifies the raw water by filtration and supplies the obtained purified water to the electrolytic chamber 40 in the electrolytic cell 4. Note that the water purification cartridge 5 can also be provided on a downstream side of the electrolytic cell 4. In this case, it is preferred that the water purification cartridge 5 is arranged so as to purify electrolytic hydrogen water, among water electrolyzed by the electrolytic cell 4.

The electrolytic water production device 1 in this embodiment is configured so that multiple kinds of genuine water purification cartridge 5 having different purification performance can be selectively mounted thereon. In this case, the user can mount a water purification cartridge 5 having better purification performance or a water purification cartridge 5 having a longer replacement time in place of a standard water purification cartridge 5.

An anode power feeder 41 and a cathode power feeder 42 are arranged so as to face each other inside the electrolytic chamber 40. A diaphragm 43 is disposed between the anode power feeder 41 and the cathode power feeder 42. The diaphragm 43 divides the electrolytic chamber 40 into an anode chamber (40a) on a side of the anode power feeder 41 and a cathode chamber (40b) on a side of the cathode power feeder 42.

Water is supplied to both the anode chamber (40a) and the cathode chamber (40b) of the electrolytic chamber 40, and DC voltage is applied to the anode power feeder 41 and the cathode power feeder 42. Thereby, water is electrolyzed in the electrolytic chamber 40.

The diaphragm 43 allows ions generated by electrolysis to pass through, thereby, electrolytic reduced water can be obtained in the cathode chamber (40b), and electrolytic acidic water is obtained in the anode chamber (40a). Further, in the cathode chamber (40b), hydrogen gas is generated by electrolysis and dissolves in the water in the cathode chamber (40b). Therefore, the electrolytic reduced water obtained in the cathode chamber (40b) is also referred to as electrolytic hydrogen water and is considered to be effective for removing active oxygen. Note that the electrolytic reduced water may be also referred to as “reduced water”, “reduction water”, “alkali reduced water”, “reduced hydrogen water”, “hydrogen water”, “alkaline ionized water”, etc.

The device main body 2 in this embodiment is provided with a flow path switching valve 22. The flow path switching valve 22 guides the electrolytic hydrogen water from the cathode chamber (40b) to a first drainage path 11 dedicated to the electrolytic hydrogen water, and guides the electrolytic acidic water from the anode chamber (40a) to a second drainage path 12 dedicated to the electrolytic acidic water. In the device main body 2 in this embodiment, in order to prevent degradation of electrolysis performance due to adhesion of scales to the power feeders, the polarity of the voltage applied to the electrolytic cell 4 is periodically switched. Even in this switching, in order to guide the electrolytic hydrogen water to the first drainage path 11 and to guide the electrolytic acidic water to the second drainage path 12, the valve of the flow path switching valve 22 is switched in synchronism with the polarity switching of the voltage.

Further, the device main body 2 in this embodiment is provided with a plurality of sensors 20 for checking operation state of the device main body 2. The sensors 20 in this embodiment include a flow rate sensor 20A for detecting an amount of water passing through the water purification cartridge 5, a temperature sensor 20B for sensing temperature of a DC power supply 21 connected with the electrolytic cell 4, an ammeter 20C for measuring electric current flowing through the electrolytic cell 4, a position sensor 20D for detecting position of the valve of the flow path switching valve 22 and a pH sensor 20E for measuring the pH value of the electrolytic water passing through the first drainage path 11, and the like. Note that the sensors 20 are not limited to those listed above.

These sensors 20 monitor the operation state of the electrolytic water production device 1. Then, for example, when the measured value of at least one of the sensors 20 deviates from a proper numerical range in a normal operation state, it is judged to be abnormal, then the operation of the electrolytic water production device 1 is stopped, and notification of occurrence of breakdown, and the like is displayed. The proper numerical range is stored as a part of internal data (B) in a memory portion 14 of a controller 8 which will be described later and the controller 8 judges whether the measured value is normal or abnormal, and stops the operation of the device and displays the notification of caution or warning when the measured value is judged to be abnormal.

The water purification cartridge 5 in this embodiment is provided with a wireless tag 6 for short-range wireless communication and storing data (A) of the water purification cartridge 5. This wireless tag 6 is also known as an electronic tag, an IC tag, an RFID (Radio Frequency Identification) tag or the like, and is a well-known storage medium which can read and write data by short-range wireless communication.

The data (A) of the water purification cartridge 5 includes identification data A1 (an ID number or the like, for example) for identifying the water purification cartridge 5. Further, in addition to the above, the data (A) can also include data relating to specification of the water purification cartridge 5, such as model number, data of recommended upper limit value of the water flow rate and data of recommended upper limit value of usage time and the like for which the water purification cartridge can function effectively.

Furthermore, the device main body 2 is provided with a communicator 7 and the controller 8. The communicator 7 in this embodiment can wirelessly communicate with the wireless tag 6 of the water purification cartridge 5 mounted on the mounting portion 10. Yet furthermore, when the communicator 7 is wirelessly connected with the wireless tag 6, the controller 8 can read data (A) from the wireless tag 6. As the communicator 7, a so-called RFID reader/writer can be suitably used.

As shown in FIG. 2, the communicator 7 and the controller 8 are arranged in the fourth space 3062, and the communicator 7 wirelessly communicates with the wireless tag 6 through the first partition wall 32A. In this embodiment, the controller 8 is attached to the circuit board 34 and the communicator 7 is attached to the first partition wall 32A. In order to suppress influence of noise outside the device, it is preferred that a shortest distance (La) between a wireless communication antenna portion 7A of the communicator 7 and an outer surface of the case 31 is larger than a shortest distance (Lb) between the wireless communication antenna portion 7A and a surface on a side of the first space 30A of the first partition wall 32A.

The controller 8 has the memory portion 14 for storing the internal data (B) of the device main body 2. Although the internal data (B) is not particularly limited, the internal data (B) in this embodiment include at least one of the followings:

(1) data B1 of genuine water purification cartridges usable for the electrolytic water production device 1
(2) data B2 of melody played during electrolysis of water
(3) data B3 of LED lighting patterns
(4) data B4 of voice or buzzer sound played at the time of caution or warning
(5) a controlling program B5 for controlling operation of the device main body 2.

The data B1 includes data of a list of model numbers of usable genuine water purification cartridges, for example. Then, the controller 8 can judge whether it is a genuine product or not by comparing the data B1 of the list of the model numbers with the data of the model number read from the water purification cartridge 5 currently mounted. However, for example, if a new water purification cartridge is released at a later date and it can be used for the electrolytic water production device 1, it is desirable to update the data B1 in order to add the model number of the new water purification cartridge to the list of the model numbers.

Further, the electrolytic water production device 1 in this embodiment is configured to play a melody (music) from a speaker during electrolysis in order to inform the user that the device is in operation and that water is electrolyzed. A plurality of melodies are stored in the memory portion 14 in advance so as to be selectable, but it is desirable to update the data B2 in order to add a new melody according to the user's preference.

Furthermore, the electrolytic water production device 1 in this embodiment is configured to flash an LED during electrolysis in order to notify the user that the device is in operation and that water is electrolyzed. A plurality of lighting patterns are stored in the memory portion 14 in advance so as to be selectable, but it is desirable to update the data B3 in order to add a new lighting pattern according to the user's preference.

Yet furthermore, the electrolytic water production device 1 in this embodiment is configured to play voice or buzzer sound at the time of caution or warning in order to notify the user that an abnormality occurred. voices of a plurality of speakers or a plurality of buzzer sounds are stored in the memory portion 14 in advance so as to be selectable, but it is desirable to update the data B4 in order to add a voice of a new speaker or a new buzzer sound according to the user's preference.

Still furthermore, in the electrolytic water production device 1, the operation of the device main body 2 is controlled by the controlling program B5, and it is desirable to update the controlling program B5 in order to improve its function.

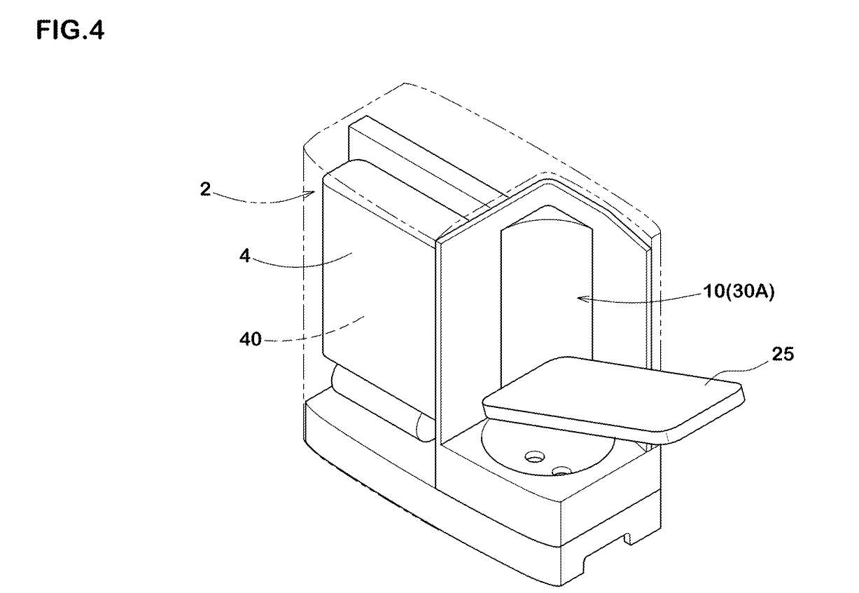

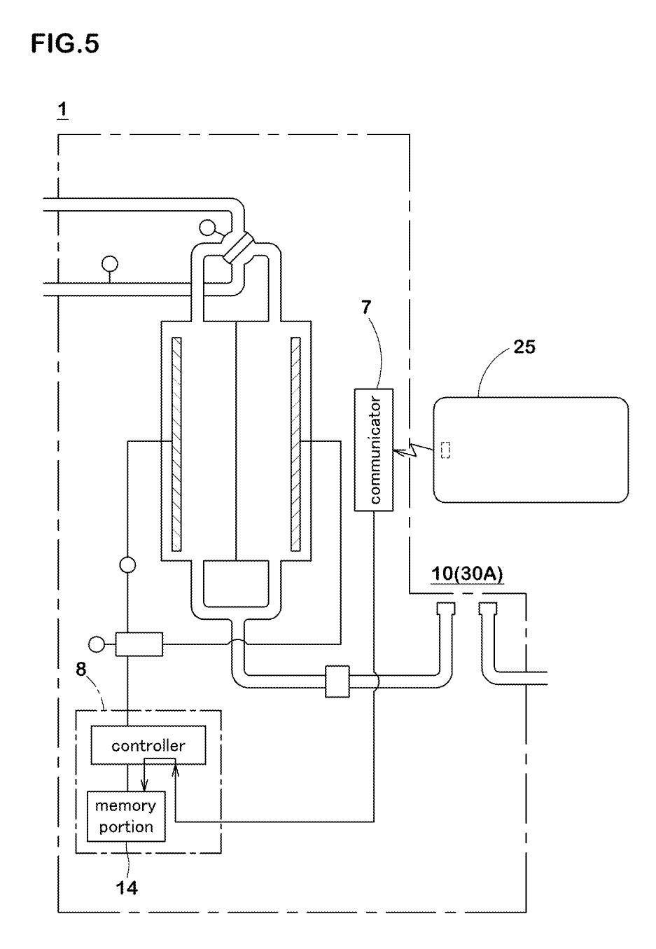

Therefore, in order to update the internal data (B), an external data medium 25 is used. More specifically, as shown in FIGS. 4 and 5, in this embodiment, when the external data medium 25 comes close to the mounting portion 10 from which the water purification cartridge 5 is removed, that is without the water purification cartridge mounted thereon, the external data medium 25 and the communicator 7 can be wirelessly connected with each other.

Although not particularly limited, the external data medium 25 needs to have at least a communication function with the communicator 7 and a storing function of the data for updating the internal data (B).

As the external data medium 25 configured as such, a dedicated device can be manufactured and used. However, it is preferred to use an existing mobile communication terminal (for example, a mobile phone and a smart phone), a tablet PC, and the like, for example. The mobile communication terminal, the tablet PC, etc. can function as the external data medium 25 by installing a dedicated application (software). It is also possible to use a wireless tag.

As a communication method between the external data medium 25 and the communicator 7, although not particularly limited, wireless communication such as Bluetooth (registered trademark), Wi-Fi, NFC, or the like can be suitably used. Then, for example, by performing look-up operation for searching the external data medium 25 for the communicator 7 in a search-enabled state, it is possible to establish a wireless connection between them.

Further, when the wireless connection is established, the controller 8 has functions of reading the data for update from the external data medium 25 and updating the internal data (B) based on the read data for update. such functions can be performed by the controller 8 having a predetermined control program.

Note that the data to be updated by the external data medium 25 can include at least one of the followings:

(1) the data B1 of the genuine water purification cartridges usable for the electrolytic water production device 1,
(2) the data B2 of the melody played during electrolysis of water,
(3) the data B3 of the LED lighting pattern,
(4) the data B4 of the voice or the buzzer sound played at the time of caution or warning,
(5) the controlling program B5 for controlling the operation of the device main body 2.

Further, it is also possible that the wireless tag 6 of the water purification cartridge 5 store the data for update. In this case, when the communicator 7 is wirelessly connected with the wireless tag 6 of the water purification cartridge 5 mounted on the mounting portion 10, the controller 8 reads the data for update from the wireless tag 6 and updates the internal data (B) based on the data for update read from the wireless tag 6. In this case, the wireless tag 6 also serves as the external data medium 25.

As an example, data of the recommended upper limit value of the water flow rate and data of the recommended upper limit value of the usage time in the data (A) of the wireless tag 6 are used as the data for update, for example. When mounting the water purification cartridge 5 on the device main body 2, the data (A) of the wireless tag 6 is read and the data of the recommended upper limit value of the water flow rate and the recommended upper limit value of the usage time stored in the internal data (B) in advance is replaced with those of the mounted water purification cartridge 5. Then, based on the replaced data of the recommended upper limit value of the water flow rate and the recommended upper limit value of the usage time, the time for replacement of the mounted water purification cartridge 5 is calculated. In this case, it is unnecessary to store in the internal data (B) the recommended upper limit value of water flow rate and the recommended upper limit value of the usage time for all usable water purification cartridges 5, therefore, the memory capacity can be reduced. Further, it is possible to easily change the replacement timing.

As described above, in the electrolytic water production device 1, it is possible to easily update the internal data (B) at a location where the device is installed without disassembling the device main body 2 and replacing the circuit board, therefore, the maintenance work time and the work cost can be decreased.

Further, by constructing a management system using the electrolytic water production device 1 and the external data medium 25 configured as such, it is possible to provide quick and high-quality service regarding the electrolytic water production device 1.

While detailed description has been made of an especially preferred embodiment of the present invention, the present invention can be embodied in various forms without being limited to the illustrated embodiment.

### REFERENCE SIGNS LIST

1 electrolytic water production device
2 device main body
4 electrolytic cell
5 water purification cartridge
6 wireless tag
7 communicator
8 controller
10 mounting portion
14 memory portion
25 external data medium

1. An electrolytic water production device comprising:
a device main body having an electrolytic cell for electrolyzing water, and
a water purification cartridge exchangeably mounted on a mounting portion of the device main body and for purifying water before or after electrolysis, wherein
the device main body is provided with a communicator and a controller having a memory portion for storing internal data of the device main body, and
when the communicator is wirelessly connected with an external data medium, the controller reads data from the external data medium and updates the internal data based on the data read from the external data medium.

2. The electrolytic water production device according to claim 1, wherein
the water purification cartridge is provided with a wireless tag,
the communicator is capable of wirelessly connecting with the wireless tag of the water purification cartridge mounted on the mounting portion, and
when the communicator is wirelessly connected with the wireless tag, the controller reads data from the wireless tag.

3. The electrolytic water production device according to claim 2, wherein
the controller updates the internal data based on the data read from the wireless tag.

4. The electrolytic water production device according to claim 2, wherein
when the external data medium comes close to the mounting portion without the water purification cartridge mounted thereon, the communicator is capable of wirelessly connecting with the external data medium, and
when the communicator is wirelessly connected with the external data medium, the controller reads data from the external data medium, and updates the internal data based on the data read from the external data medium.

5. The electrolytic water production device according to claim 1, wherein
the data to be updated based on the data read from the external data medium includes at least one of
data of types of the water purification cartridge usable for the electrolytic water production device,
data of melody played during electrolysis of water,
data of LED lighting patterns,
data of voice or buzzer sound played at the time of caution or warning, and
a controlling program for controlling operation of the device main body.

6. The electrolytic water production device according to claim 1, wherein
the external data medium is a mobile communication terminal or a tablet PC.

7. A management system for an electrolytic water production device comprising the electrolytic water production device and the external data medium according to claim 1.
